(19) United States
(12) Patent Application Publication
(10) Pub. No.: US 2010/0212021 A1
(43) Pub. Date: Aug. 19, 2010

(54) Decrement software

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/372,994

(22) Filed: Feb. 18, 2009

(51) Int. Cl. G06F 21/00; G06Q 10/00; G06Q 50/00

(52) U.S. Cl. 726/27; 705/7

(57) ABSTRACT

Computer system that detects license characteristics, and detects if the use of specified software is within those license characteristics. If not, the software use is limited to less than the specified use. This allows all versions of the software to have all features, but limits the amount by which those features can be used.

### BACKGROUND

Software is created by software developers and used by users. Users typically pay a fee in return for a license to the software. Improper use of software or unlicensed use of software may lead to loss of revenue for the software company.

Software is sold as a product to a user. Different software versions may have different features and have different prices for the software. Sometimes students or home users get a discount on software that is offered at a higher price to commercial users.

### SUMMARY

Embodiments describe software and licensing for the software that based on an actual use that is made of the software. According to an embodiment, multiple versions of the software all get the same software features, but use of those features are monitored, e.g, automatically, to determine license characteristics.

An embodiment determines whether the use being made of the software is appropriate for the purchased license.

An embodiment determines use of a single license on multiple different computers.

### BRIEF DESCRIPTION OF THE DRAWINGS

These and other aspects will now be described in detail with reference to the accompanying drawings, wherein:

FIG. 1 shows software installed and/or used on multiple computers;

FIG. 2 shows a flowchart of operation; and

FIG. 3 shows a flowchart of determining whether software use is the same as authorized.

### DETAILED DESCRIPTION

Software developers have explored different models of securing payment for the use of software. For example, it has been suggested to use software that is only usable a certain number of times. Software use over the Internet can be used to monitor the amount of use of the software that is being made. Various forms of pay per use and/or pay per click software have been suggested. However, the most convenient way to distribute software is simply to distribute the software as a product, along with a license to the software to use whatever features are within that software. Different users or versions may have different features.

However, a basic inequity follows from the fact that someone who uses software all day, e.g., for their livelihood, pays the same amount for a software license as someone who uses the software only very occasionally. For example, someone working in an office all day may have word processing products open and in use 8 hours a day. It seems unfair that these users pay the same amount for the software as someone who uses it once a month to write a card or a letter. Many people use pirated software on their home computers, believing that it is not fair to be charged a license fee when all they do is some limited amount of use. Accordingly, some may feel moral justification in stealing or otherwise misappropriating using the software, since the license fee is not appropriate to their amount of use.

Home users have sometimes been charged less than business users. The lesser-priced version may have a reduced feature set. Students can get student versions. However, a home user might want the same feature set as the professional user, but use those features less often. Non-students may get the student version of the software. Pay per click software systems have been suggested.

The inventor believes that the real question is: what are you doing with the software and how often are you doing it? The real question is 1) what is a person doing, and 2) not how many times total one does something, but rather how often things are done per unit time.

Someone who uses the software once per hour is using it in a wholly different way than someone who uses the software once per week or than a person who uses the software all day long.

Working on legal documents all day is different than working on student reports.

Moreover, the fact that someone has two computers and can not use them at once does not mean that they should necessarily pay more for licensing that a person who only uses the software only on one computer. If a person moves from place to place, it might make sense to use the same software license in each of those places.

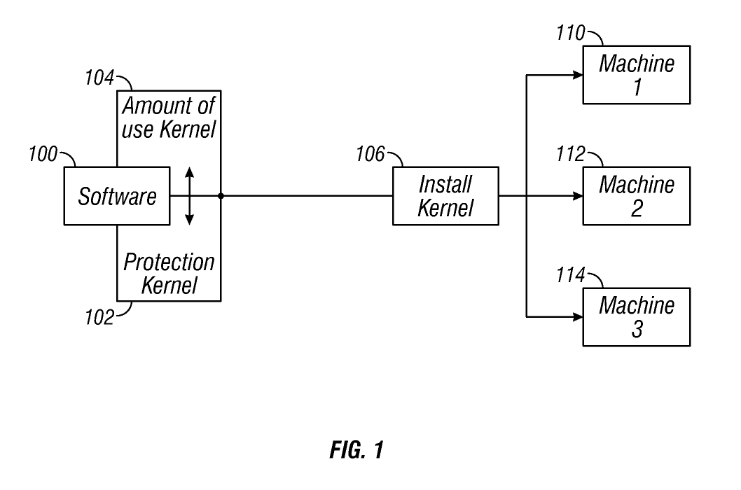

An embodiment is shown in FIG. 1. The software 100, which can represent a storage medium holding the software, or a server that stores software that can be installed over the server or in some other way, is shown. The software can be any software that carries out functions on the computer system. These functions preferably change the contents on a display on the computer system. The software can be for example, word processing software, spreadsheet, presentation 3d modeling, drawing or other similar software.

A protection kernel 102 and an amount of use kernel 104 may be included in the software. An install kernel 106 may allow the software to be installed on a number of different machines according to a rule that governs the amount of use of the software on the machines. The software and the kernels may all be on the same machine or may be on multiple machines.

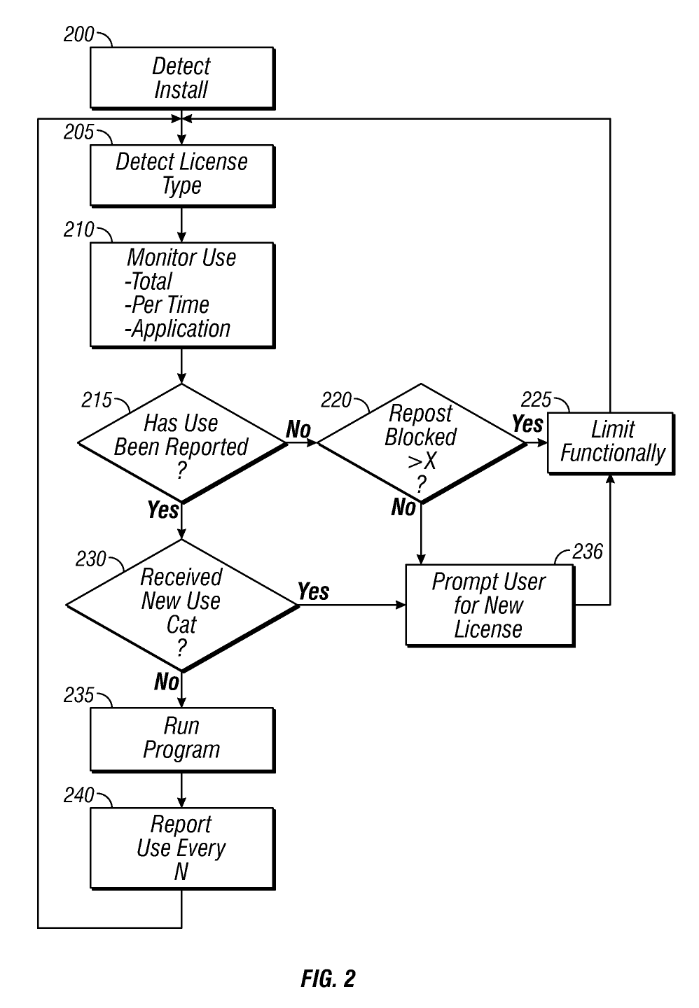

For example, FIG. 1 shows the software being installed on machine one (110), machine two (112), and machine three (114). The protection kernel 102 prevents the software against unlicensed use. The amount of use kernel 104 determines the amount of use of the software on all the machines, or in an embodiment where the software is being used on only one machine, measures the amount of use on only that one machine. The install kernel 106 operates along with the amount of use kernel and protection kernel as shown in the flowchart of FIG. 2.

FIG. 2 starts with an initial operation at 200 of detecting installation of the software. In embodiments, the software can be any software that allows an operation on the computer system: e.g., a word processing program, spreadsheet, image creation or editing, modeling or 3d program, or any other kind of program that does anything on the computer.

205 detects the license type. An embodiment may use a number of different grades of license types. A personal license type might be for someone who uses the machine only rarely for personal use. For example, this might be someone who writes e-mails in the evening, occasionally writes a document, and might work with the computer on the weekend. Someone who does personal things more often might be considered a heavy personal user. A work user may be someone who uses the program for work, and hence uses the program either every day or almost every day, or at least most days when the computer is turned on, for a certain time period. Other license types may also exist.

At 210, the system monitors use of the software as a function of the number of things that are done per time—e.g., per time of operation of the computer and/or per absolute time. One embodiment can monitor how often are documents being created in each work day period. Another may monitor how often documents are edited or opened in that period. The monitoring is not just of total amounts, rather of the frequency (how often per period) at which things being done.

When a document is accessed each day once, this is not the same as accessing different documents all day long.

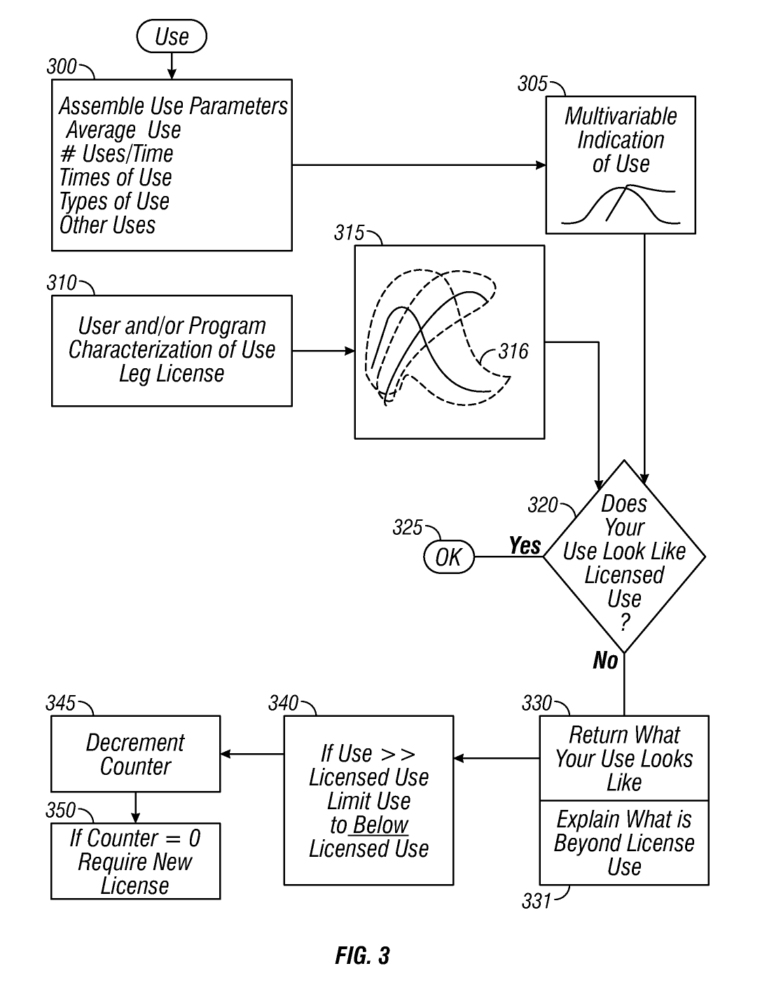

In one embodiment, all of the use may be analyzed on the local computer itself, according to for example the flowchart of FIG. 3 described herein. In another embodiment, however, the license may be a license for use on multiple computers and that use may hence be distributed across multiple different computers. The use per computer, or total use of all the computers may set the license.

215 checks whether the use has been reported. In an embodiment, this may check to determine if this computer has connected to a central server to report that use has been carried out and receive information about other uses. If the use has not been reported, this can mean that the reporting is blocked at 220. If the reporting has been blocked for a certain amount of time, for example for 10 days, the functionality of the program may be limited at 225. This limited functionality may still allow the program to be used, however may prevent certain operations, such as preventing creation of a new document, but allowing previous documents to still be edited.

If the use has been reported at 215, 230 tests to see if a new use category has been received. A new use category may be received, for example, when the user is using the program in a way that is inconsistent with the license that they have purchased. For example if a student is using the program in a way that a commercial user would use it, this might indicate that the use is not in accordance with the license. When this happens, at 235, the user is prompted for a new license. After a certain amount of time, flow may pass to 225 which limits the functionality of the program.

In one embodiment, the functionality of the program may be limited in a way that constains the software use to be more like the license that has been purchased. For example, if the license is for student use, the use may be limited in a way that limits the program to student-like uses.

Unlike other systems that may limit features for certain program versions, an embodiment allows all versions to use all features, as long as the use is not of an amount that would indicate a different license. However, when the use exceeds that license, then certain features are disabled, at least for an amount of time to bring the average use back into appropriate parameters.

For example, a student might write two long (e.g., over 30 pages) reports per week. If the student writes five long reports per week, then the program may be limited to prevent saving any report longer than 30 pages at all, until the average number of over 30 pages per report is lowered to 2 per week.

If the use is inappropriate for the license, program use is constained. The constrained use will eventually cause 210 to determine that the amount of use is more appropriate for the specific license that has been purchased. Lack of use of the functionality will cause the functionality limit will be removed.

In an embodiment, the use constraint may be more constrained than the normal average use that would be associated with the purchased license. This more constrained use may be lower than the approved average use so that the average use is reduced over time

If everything is ok, then 235 runs the program, and continues to report use every specified time at 240.

FIG. 3 shows an exemplary plot of the specific uses and how this can be carried out. At 300, the number of uses is assembled. This includes, as described above, 1) what the user is doing with the program, and 2) how often the user is doing those things. The uses may include the times when the program is used, e.g during business hours or not. Part of this may determine

when are the most uses?

how many documents are actually used with the program?

how large are those documents?

Is the program being primarily used for business or primarily pleasure?

That is, for a word processing program, is it being used primarily for creating student reports or professional reports? For a browser program, is it used for browsing pleasure websites or commercial websites?

What is the average amount of use?

How long elapses between use sessions? Each use session may be a use by the user at a computer. The use sessions may last any amount of substantially uninterrupted use, or a period during which the computer is used. For example, use sessions may last for a whole weekend.

The frequency of the use sessions may also be monitored.

median amount of use during each use session. This may cause the unusual excessive periods of use to become “outliers”.

what times of day/week is the computer typically used? After business hours/weekends, vs during work hours. One license may be an “after business hours license”. This predominately allows use after business hours. However, use of the computer on a sick day will not effect this licensed validity, as long as the sick days do not become excessive, e.g, more than 10%

other indications of commercial activity versus personal or student activity.

The system may monitor any parameter. All the parameters jointly may form a feature vector.

310 indicates an indication of the user's use. For example, the user may characterize their use by the kind of license that has been purchased. For example if the user has purchased a student license, they have characterized their use as being student. The actual number of uses is shown in 305 as a histogram, which indicates the kinds of uses and when these carry out carried out. This could alternatively be a feature vector or any other format that characterizes multiple instances of how the software is being used.

The characterization of the uses is shown as 315. The two histograms or feature vectors represent the multivariable indications of use, including the use factors noted above. The indications of use might be the same and/or may have differences. These multivariable indications of use can be compared. For example, an acceptable histogram of student use may be shown in the dotted lines in 315. Anything within the dotted line 316 may be considered acceptable use for the license that was purchased. If the actual use 305 is within the dotted line 316, then the actual use may be acceptable use.

According to an embodiment, multiple different indications of use are compared, however, not all indications of use need to be compared. For example, one embodiment might compare only two of the factors of use.

The indication of whether the use looks like what you have licensed is determined at 320. The system determines whether the actual use is within the parameters of what the user has licensed. If so, then an “ok” indication is returned at 325. This “ok” indication means that the use category that has been licensed is appropriate to the use being made. Hence there is no new use category at step 230.

If the new use at 320 does not match the licensed use, then 330 returns a new use category. The operation may also return an indication of what the actual use looks like and/or why the actual use exceeds the licensed use at 331. 340 determines if a user's use is much greater than their licensed use, e.g, by an amount or over a period of time.

For example, a user might use the software very often over a weekend, then return to their normal use level. The period of excessive use, however, is all taken as a single use session. Even though this may exceed the average use, this will not trigger a use exception.

If the use is excessive, then 340 limits the use to a level that is below the licensed use, by actually preventing certain software features. For example, this may limit the times when the software can run, or what kinds of things it can open. The limit will eventually cause the use parameters assembled at 300 to return back to a licensed use amount. The limit may last for a minimum period of time, e.g, for 1 day. After that, the use may return to normal.

At 345, a counter is decremented. This counter represents the total number of times that it is allowable to exceed the threshold. For example, the counter may be set to 10—and if the user exceeds the allowable use by 10 times, then the user will need to get a new license at 350. The counter may be reset, for example, every year. This limits abuse of the licensing scheme by limiting the number of times that the licensed use can be exceeded.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operation over the internet, any other way of interacting via a shared network can be similarly done in this way. Another embodiment may operate over a wholly internet and/or wireless system. The above has described certain kinds of software being protected and use-characterized in this way, but other devices and/or software can be similarly protected. For example this protection/payment system can be used for maps such as gps mapping to require payment based on the number of uses of the maps that are made.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A computer system, comprising:
a computer system running a software program that carries out an operation on said computer system;
a use monitoring element, that monitors at least one aspect of the use of the software program on the computer system; and
a license detection element that detects whether said use that is monitored by said use monitoring element matches a licensed use, and limits a use of said software program when said use exceeds said licensed use, while allowing said software program to continue running at the limited use.

2. A system as in claim 1, wherein said license detection element detects one of a plurality of different license types, wherein each of said license types represents an amount of use to be made of the software program, and each of said different license types allow substantially all the same software features, but specify information indicative of an acceptable use of said software features.

3. A system as in claim 1, wherein said use monitoring element monitors use on plural different computer systems, where said plural different computer systems each share a same license, and said use monitoring element aggregates said plural uses so that said license detection element detects whether the aggregated use exceeds the licensed use.

4. A system as in claim 2, wherein said use monitoring element detects multiple different variables, which collectively indicate a use of the program, and said license detection element analyzes each of said multiple variables to determine whether the use of the program exceeds the licensed use.

5. A system as in claim 1, wherein said use monitoring element determines an amount that the program is being used during normal business hours and wherein said license detection element limits an amount of use only when the program is used within normal business hours by more than a specified nonzero amount.

6. A system as in claim 4, wherein said license detection element analyzes an average amount of use of said program, and also analyzes a feature for which said program are used, and limits a use of said program only when both said average amount of use exceeds a first specified nonzero threshold and said program is used to create at least one specified feature more than a specified number of times.

7. A system as in claim 6, wherein said limits use comprises reducing and allowable amount of use to a second threshold that is less than said first threshold.

8. A system as in claim 1, wherein said limit use comprises limiting a functionality of the program in a way that constrains this software used to be more like the license that has been purchased.

9. A system as in claim 1, wherein said use monitoring element monitors use of the computer program that is outside business hours, and said license detection element limits use of the computer program when the use outside business hours exceeds a specified nonzero threshold.

10. A system as in claim 9, wherein said use outside business hours detects use over a weekend.

11. A computer program product comprising a computer usable medium having a computer readable program code embodiment therein, said computer readable program code adapted to be executed to implement operations comprising:
executing instructions to carry out functions on said computer system, said functions changing a display on the computer system;
monitor at least one aspect that represents use of the software program on the computer system;
access stored information indicative of a license for the software program, when the information includes information that indicates an acceptable category and amount of use of said software program; and
detect whether said use that is monitored matches a licensed use indicated by said information, and limit a use of said software program when said use exceeds said licensed use by a specified amount, while allowing said software program to continue running at the limited use.

12. A product as in claim 11, wherein said stored information represents one of a plurality of different license types, and each of said different license types allow substantially all the same software features, but specify information indicative of an acceptable use of said software features.

13. A product as in claim 11, wherein said use monitor monitors use on plural different computer systems, where said plural different computer systems each share a same license, and aggregates said plural uses so that said detects is whether the aggregated use exceeds the licensed use.

14. A product as in claim 11, wherein said use monitor detects multiple different variables, where said different variable collectively indicate a use of the program, and said detect analyzes each of said multiple variables to determine whether the use of the program exceeds the licensed use.

15. A product as in claim 11, wherein said monitor element determines an amount that the program is being used during normal business hours and wherein said detect limits an amount of use only when the program is used within normal business hours by more than a specified nonzero amount.

16. A product as in claim 14, wherein said detect analyzes a feature for which said program is used, and amounts of use of said feature, and also analyzes and limits a use of said program only when both said average amount of use exceeds a first specified nonzero threshold and said program is used to create at least one specified feature more than a specified number of times.

17. A product as in claim 16, wherein said limits use comprises reducing an allowable amount of use to a second threshold that is less than said first threshold.

18. A system as in claim 11, wherein said use monitoring element monitors use of the computer program that is outside business hours, and said license detection element limits use of the computer program when the use outside business hours exceeds a specified nonzero threshold.

19. A system as in claim 9, wherein said use outside business hours detects use over the weekend.

20. A computer system, comprising:
a computer system running a software program that carries out an operation on said computer system, said operation changing a display output from said computer system;
a use monitoring element that monitors a times and days when the software program is used on the computer system, and detects whether a use of the software is used outside business hours by a specified nonzero amount; and
a use limiting part that limits a use of said software program when said use of the computer program exceeds a specified nonzero threshold, while allowing said software program to continue running at the limited use.

21. A system as in claim 20, wherein said use outside business hours detects use over a weekend.
